(19) United States
(12) Patent Application Publication
(10) Pub. No.: US 2022/0003495 A1
(43) Pub. Date: Jan. 6, 2022

(54) Systems and Methods for Controlling the Temperature of a Fluid

(71) Applicant: Bayerische Motoren Werke Aktiengesellschaft, Muenchen (DE)

(72) Inventors: Julian EICHHORN, Menlo Park, CA (US); Zoltan MAJOR, Muenchen (DE); Jasper STERN, Muenchen (DE)

(21) Appl. No.: 17/291,899

(22) PCT Filed: Nov. 13, 2019
(86) PCT No.: PCT/EP2019/081098

§ 371 Date: May 6, 2021

(30) Foreign Application Priority Data
Nov. 15, 2018 (DE) 10 2018 128 710.0

(51) Int. Cl. F25D 31/00; B60N 3/10

(52) U.S. Cl. CPC F25D 31/007; B60N 3/104; F25D 2700/16; F25D 2700/14; F25D 2700/06

(57) ABSTRACT

A method for controlling the temperature of a fluid in a container received by a retaining device is provided. The retaining device includes one or more temperature controllers which are configured to control a temperature of the fluid. The method includes detecting a container accommodated in the retaining device; determining one or more parameters; determining a target temperature based on the one or more parameters; detecting the temperature of the fluid; determining a deviation between the target temperature and the detected temperature; and controlling the one or more temperature controllers based on the deviation.

### BACKGROUND AND SUMMARY OF THE INVENTION

The disclosure relates to systems and methods for controlling the temperature of a liquid. The disclosure relates in particular to systems and methods for controlling the temperature of a liquid, for example a drink, in motor vehicles.

The related art has disclosed holding apparatuses for liquid containers in vehicles, which holding apparatuses are of stowable or foldable design so as to be able to be stowed in an invisible or space-saving manner when not in use. Furthermore, holding apparatuses which can maintain, increase or reduce the temperature of a liquid in a container, for example cool a soft drink or keep coffee or tea warm, are known.

The document DE 10 2014 113 860 A1 describes a system consisting of at least one guide and at least one module which is displaceable along the guide and which serves for accommodating objects. The guide has a current supply, and the at least one module has a current collection device and a drive unit. In order to achieve a movement of the at least one module, the drive unit is connected to the current collection device and the at least one module is movable along the guide via the drive unit and controllable via a control unit.

The document U.S. 2018/111535 A1 describes a drink container for motor vehicles that is connected to a vehicle air-conditioning system and to a current supply in order to heat and to cool a contained drink to a predetermined temperature.

In known apparatuses and systems, it typically has to be set by the user himself or herself whether a drink is to be cooled or kept warm. In particular, the user has to specify a desired target temperature, even in cases in which a sensor system automatically detects whether a cold or hot drink is involved. Ideally, a temperature of the drink is automatically detected and a conventional cooling or keeping-warm process is thereupon triggered.

Manual operation by a user may have various disadvantages. For example, manual setting requires the attention of the user. If the user is the driver of a motor vehicle, attention required for the use of the function should be reduced to a minimum or be completely avoided.

A possible manual operation furthermore always also includes the possibility of incorrect operation. Excessive heating or unintentionally intense cooling of the liquid is to be avoided for safety reasons. This can entail undesired effects, for example scalding of the user by the liquid, damage to the liquid container or the holding apparatus and/or escape of the liquid.

The presently disclosed methods and systems allow more reliable or more accurate determination of a desired target temperature for a liquid contained in a container, in particular if a user does not give any manual specifications nor make any settings. This makes it possible in particular for a presetting which has to be changed manually by the user only rarely or not at all to be able to be provided. Therefore, a necessary number of interactions of a user can be reduced or minimized and consequently the attention of the user on essential things, for example on road traffic, can be improved.

It is an object of the present disclosure to provide systems and methods for controlling the temperature of liquids that avoid one or more of the aforementioned disadvantages and/or make possible one or more of the described advantages.

Said object is achieved by the subject matter of the claimed invention.

A first aspect according to embodiments of the present disclosure specifies a method for controlling the temperature of a liquid in a container received by a holding apparatus, the holding apparatus comprising one or more temperature controllers which are configured to regulate a temperature of the liquid. The method comprises detecting a container accommodated in the holding apparatus, determining one or more parameters, determining a target temperature on the basis of the one or more parameters, detecting the temperature of the liquid, determining a deviation between the target temperature and the detected temperature, and controlling the one or more temperature controllers on the basis of the deviation.

In a second aspect according to aspect 1, the one or more temperature controllers are configured to regulate the temperature of the liquid indirectly at least via one part of the container. Preferably, the part of the container comprises at least one part of a base of the container and/or at least one part of a side wall of the container.

In a third aspect according to either of aspects 1 and 2, controlling the one or more temperature controllers comprises controlling the one or more temperature controllers to increase the temperature of the liquid to the target temperature, or controlling the one or more temperature controllers to reduce the temperature of the liquid to the target temperature. Alternatively or additionally, controlling the one or more temperature controllers comprises controlling the one or more temperature controllers to keep the temperature of the liquid substantially equal to the target temperature.

In a fourth aspect according to one of aspects 1 to 3, the one or more parameters comprise one or more user-specific parameters which are configured to map an input by or a behavior of a user.

In a fifth aspect according to the preceding aspect 4, the one or more user-specific parameters comprise a desired target temperature, in particular in each case for hot drinks or cold drinks, and/or a desired minimum temperature, and/or a desired maximum temperature, and/or a temperature input at an earlier point in time.

In a sixth aspect according to one of aspects 1 to 5, the one or more parameters comprise one or more context-specific parameters which are configured to map a context of the method.

In a seventh aspect according to the preceding aspect 6, the one or more context-specific parameters comprise an internal surroundings temperature, which indicates an inside temperature; and/or an external surroundings temperature, which indicates an outside temperature; and/or a time of day; and/or a date; and/or a place.

In an eighth aspect according to one of aspects 1 to 7, the method further comprises detecting an input by the user; and determining the target temperature on the basis of the input, and preferably also on the basis of the one or more parameters.

In a ninth aspect according to one of aspects 1 to 8, the method further comprises detecting whether a container is accommodated in the holding apparatus; and deactivating the one or more temperature controllers if no container is accommodated in the holding apparatus.

In a tenth aspect according to one of aspects 1 to 9, the method further comprises detecting whether a container accommodated in the holding apparatus contains a liquid; and continuing the method with the step of detecting the temperature of the liquid if the container accommodated in the holding apparatus contains a liquid.

An eleventh aspect specifies a system for controlling the temperature of a liquid in a container. The system comprises a holding apparatus which is configured to accommodate one or more containers; one or more temperature controllers which are configured to regulate the temperature of a liquid in a container received by the holding apparatus indirectly at least via one part of the container; and a control unit which is connected to the one or more temperature controllers and which is configured to carry out the method according to the embodiments described here.

A twelfth aspect specifies a vehicle comprising a system according to the embodiments described here for controlling the temperature of a liquid in a container. The vehicle is preferably a motor vehicle.

Exemplary embodiments of the disclosure are illustrated in the figures and will be described in more detail below. Here, the same reference signs are used below for identical elements and elements of identical action, unless indicated otherwise.

### BRIEF DESCRIPTION OF THE DRAWINGS

FIG. 1 schematically shows the structure of a system according to embodiments of the present disclosure.

FIG. 2 shows a flow diagram of a method according to embodiments of the present disclosure.

### DETAILED DESCRIPTION OF THE DRAWINGS

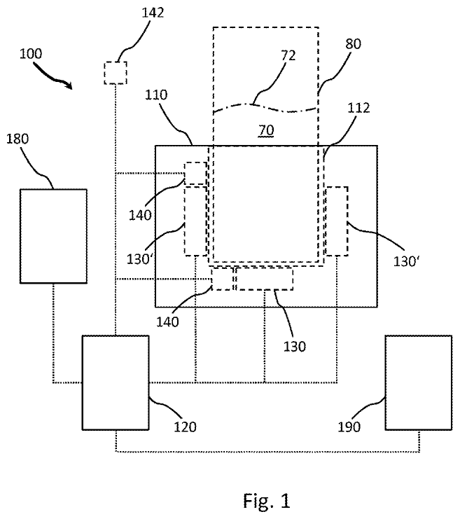

FIG. 1 schematically shows the structure of a system 100 according to embodiments of the present disclosure. FIG. 1 schematically shows a cross section of a holding apparatus 110 according to one embodiment of the present disclosure. The holding apparatus 110 is configured to accommodate one or more containers 80. FIG. 1 shows an exemplary embodiment of the holding apparatus 110, which can accommodate a single container 80. The holding apparatus 110 is selectively designed to be able to accommodate multiple containers 80, preferably at least two containers 80.

The holding apparatus 110 may furthermore be designed to be transferred in a foldable, countersinkable or some other movable manner from an inactive state (for example so as to be folded in, countersunk, stowed), in which the holding apparatus 110 is not in use, into an active state (for example so as to be unfolded, deployed), and vice versa. This design has advantages with regard to the space requirement, such that, in the case of the holding apparatus not being used, the space required for use can be freed up or used in some other way. Typically, a user can transfer the holding apparatus 110 from the inactive state into the active state and back by actuating an operator control element. The transfer itself may be realized by the user (for example mechanically) or automatically (for example electrically).

The holding apparatus 110 correspondingly comprises one or more receiving openings 112, which are in each case configured to receive a container 80. The holding apparatus 110 is designed in such a way that the container(s) 80 can be securely accommodated, essentially regardless of the specific design, shaping or size of a container 80 or the filling state thereof. This makes it possible for a multiplicity of different containers 80 to be able to be used and transported reliably in the vehicle. For the sake of simplicity, merely one receiving opening 112 is illustrated in FIG. 1. A holding apparatus 110 may, as already mentioned, have (e.g. next to one another) multiple receiving openings 112, each configured to receive a container 80. In some embodiments, differently formed receiving openings 112 may be provided in order for it to be possible for containers 80 of different sizes or of different designs to be received in an in each case matching receiving opening. Alternatively, the receiving opening(s) may be of variable form in order to receive containers 80 of different types.

The system 100 furthermore has a control unit 120, a current source 190 and a user interface 180, wherein the control unit 120 is connected to the current source 190 and the user interface 180. The current source typically comprises an on-board electrical system of a vehicle, which can have for example a voltage of 12 V, 24 V or 48 V. The current source 190 is configured to supply electrical energy to the control unit 120 and further components of the system 100. The user interface 180 is configured to communicate information to a user (for example via voice output or by way of a screen display) and to detect inputs by the user (for example via voice input, touchscreen or other operator control elements). The user interface 180 may be an independent component (for example a single touchscreen) or an integrated component which integrates multiple elements, for example of an infotainment system provided in the vehicle (for example touchscreen, rotary/push actuator or iDrive, operator control elements, gesture control, voice control and so forth).

The system 100 furthermore has one or more temperature controllers 130, 130′, which are connected to the control unit 120 and are preferably integrated into the holding apparatus 110. The temperature controllers 130, 130′ are configured to regulate the temperature of a container 80 and/or of a liquid 70 contained in the container 80. Typically, the temperature controllers 130, 130′ comprise electrically operated heating or cooling elements which can be controlled by the control unit 120 to perform a heating or cooling function. In some embodiments, the temperature controllers 130, 130′ may alternatively or additionally be connected to a heating or cooling system of the vehicle (not shown) such that the cooling or heating power of a heating or cooling system provided in the vehicle may be used for the control of the temperature of the container 80 or of a liquid 70 contained in the container 80 (for example via warm- or cold-air vents).

The system 100 furthermore has one or more sensors 140, 142, which are connected to the control unit 120 and may be integrated into the holding apparatus 110 or arranged externally in relation thereto. The one or more sensors 140, 142 may comprise one or more temperature sensors which are configured to detect a temperature of a container 80 and/or a temperature of a liquid 70 contained in the container 80. Temperature sensors may be configured separately from the temperature controllers 130, 130′ or in a manner integrated therewith.

The sensors 140, 142 may furthermore comprise optical sensors (for example photodiodes, infrared sensors, CCD sensors) which are configured to detect a temperature of a container 80 and/or a temperature of a liquid 70 contained in the container 80. For example, an optical sensor provided in the vehicle may directly measure the temperature of a liquid 70 contained in a container 80 if the container 80 is not provided with a cover or closed off in some other way. Additionally or alternatively, optical sensors may be configured to detect further properties of a container 80 (for example shape, size, imprint, in particular barcode or QR code). For example, an optical sensor provided in the vehicle may detect a container 80 in such a way that properties of the container, such as for example its size, material, shaping and the like, can be detected. In particular, an imprint present on the container 80, for example a barcode or a QR code, may be detected such that the control unit 120, on the basis thereof, can draw conclusions about the liquid 70 contained in the container and thus, for example, can distinguish between hot drinks and cold drinks.

The sensors 140, 142 may comprise further sensors which are configured to detect properties of a container 80 and/or of a liquid 70 contained in the container 80. For example, one or more pressure sensors may detect a weight of the container 80. A fill level 72 of the container 80 can then be inferred on the basis of the detected weight of the container 80. In particular in combination with further parameters, for example in combination with a (for example optically) detected barcode from which a specific container 80 can be inferred, the properties of which container can be retrieved locally in the control unit 120 (for example local memory) or via a communication connection from a suitable database (for example remote memory), it is possible to determine a current fill level 72 of the container 80 very accurately.

It is also possible in this way for further parameters to be determined very accurately. For example, on the basis of a barcode, it can be established that a soft drink (type of contents, expected desired temperature) obtainable in a PET bottle (material, size, thermal conductivity) is involved, wherein the detected weight of the container 80 can be compared with an unladen weight of the container 80 and/or with a weight of the container 80 in the completely filled state. On the basis of the detected fill level 72 (for example 50% or 250 ml) and the determined properties of the container 80 (for example PET reusable bottle), the control unit can then control the temperature controllers 130, 130′ with a suitable power (for example cooling power) in order to achieve and/or maintain a desired temperature (for example 12° C.).

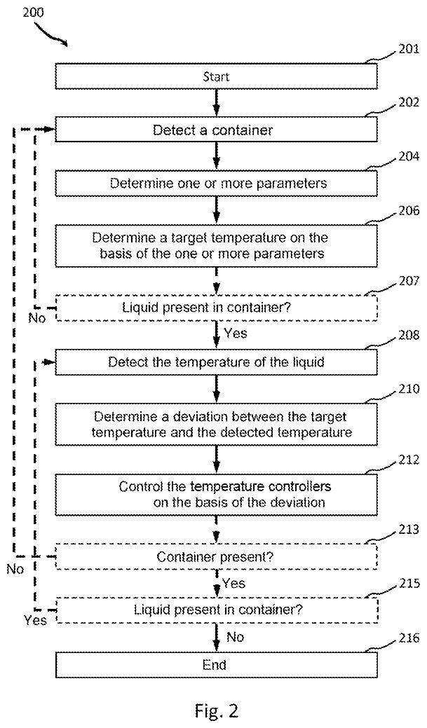

FIG. 2 shows a flow diagram of a method 200 according to embodiments of the present disclosure for controlling the temperature of a liquid 70 in a container received by a holding apparatus 110. The holding apparatus 110 comprises one or more temperature controllers 130, 130′ which are configured to regulate a temperature of the liquid 70. The method 200 begins at step 201.

In step 202, a container 80 accommodated in the holding apparatus is detected. The detection may, as described above, be realized by one or more sensors 140, 142 and comprise in particular the determination of container-specific properties or parameters (see also step 204).

In step 204, one or more parameters are determined. The determined parameters may comprise one or more of the following parameters: one or more container-specific parameters, one or more context-specific parameters, and one or more user-specific parameters.

As described above, it is preferably the case that not only is the presence of a container 80 detected in step 202, but also, preferably, there are determined, in step 204, one or more container-specific parameters, for example comprising a type of the container 80, its size, material properties, fill level, the type of the contained liquid, a typical standard temperature for the consumption of the contained liquid, minimum and/or maximum temperatures for the consumption, and so forth. On the basis of these (and possibly further) parameters, a desired target temperature of the liquid 70 contained in the container 80 can be determined more reliably or more accurately, in particular if a user does not give any manual specifications nor make any settings.

In step 204, it is preferably furthermore the case that one or more context-specific parameters are determined. Context-specific parameters relate to the context of the use of the system 100 by a user, for example a driver or a front-seat passenger in a vehicle. Parameters determined in this case may comprise surroundings data, in particular an external temperature outside the vehicle and/or an internal temperature in the interior compartment of the vehicle, date/time/place of use, settings of the air conditioning of the vehicle (for example heating, cooling) and/or a current driving state (for example urban traffic, stop-and-go, highway driving at high speed). For example, when outside or interior-compartment temperatures are relatively high (for example in summer), users typically prefer cold or relatively cool drinks, whereas when temperatures are relatively cool or on cold days (for example in winter), users typically prefer warm or hot drinks. On the basis of such context-specific parameters, a desired target temperature of the liquid 70 contained in the container 80 can be determined more reliably or more accurately, in particular if a user does not give any manual specifications nor make any settings.

In step 204, it is preferably furthermore the case that one or more user-specific parameters are determined. A user can be determined in the vehicle typically via a key assigned to him or her personally or, for example in the case of car sharing, via corresponding authentication. On the basis thereof, user-specific parameters, for example settings or inputs made in the past, can be determined. The control unit 120 may be configured for example to detect the settings made by a user, for example concerning a desired target temperature for a specific drink, over specific periods of time and to store said settings in a local memory or in some other way, so that a specific preference or habit of the user can be mapped and adopted as a typically desired presetting. Such a detection may in particular be realized in a manner based on time and/or place, so that corresponding habits can be correspondingly detected and mapped according to a context (for example time of year, place, temperature). In this way, a probably desired target temperature can be determined in a manner dependent on time, place, temperature, container 80 and/or liquid 70 and provided as a presetting. This makes it possible in particular for the control unit 120 to be able to provide a presetting which has to be changed manually by the user only rarely or not at all. This can reduce or minimize a necessary number of interactions of the user with the system 100 and thus improve the attention of the user on essential things, for example on road traffic.

Further user-specific parameters may comprise for example: a desired target temperature for hot drinks, a desired target temperature for cold drinks, minimum and maximum temperatures for specific drinks, previously (manually) set target temperatures, in particular in specific context (for example outside temperatures, date/time of year, etc.), and so forth.

In step 206, a target temperature is determined based on the one or more parameters. In this step, as described above with regard to individual parameters or parameter groups, an expected target temperature of a liquid 70 contained in a container 80 is determined. Ideally, it is in this way possible for manual interaction of the user for the setting of the temperature control to be avoided if the determined target temperature corresponds to, or deviates only slightly from, the target temperature desired or expected by the user. According to the invention, the target temperature is determined multiple times, permanently, cyclically and/or in a recurring manner, in order to take into account for example a user input which comprises a change to the target temperature, or a change to the one or more parameters. For example, it may occur that a user would like to increase or reduce the temperature of a drink in deviation from a specification. For this purpose, the user can make a corresponding input using the user interface 180 (for example by way of a touch screen, voice input, actuation of an operator control element). It is equally possible for one or more of the one or more parameters to be changed. The target temperature is determined again on the basis of such inputs or changes and the method is continued in step 208.

In step 208, the temperature of the liquid 70 is detected. This may, as described above, be realized via one or more sensors 140, 142. The one or more sensors 140, 142 may be configured to measure the temperature of the liquid 70 contained in the container 80 directly, or indirectly via at least one part of the container 80 (for example a part of the base of the container 80 and/or a part of a side wall of the container 80).

In step 210, a deviation between the target temperature and the detected temperature is determined. Here, the control unit 120 can preferably determine a deviation comprising a degree of deviation, based on which the control unit can then control the temperature controllers 130, 130′. For a large deviation or a high degree of deviation (for example a cooled hot drink or a soft drink which has become warm), temperature control (for example heating or cooling) with increased power (for example heating or cooling power) can then be realized.

In step 212, the temperature controllers 130, 130′ are controlled on the basis of the deviation. On the basis of the deviation, the temperature controllers 130, 130′ are controlled to bring the detected temperature of the liquid 70 to the target temperature (for example by heating or cooling) in as short a time as possible and/or to keep the liquid 70 at said target temperature.

The method 200 preferably begins in response to a placement of a container 80 in the holding apparatus 110, which is detected in step 202, and preferably ends with removal of the container 80 from the holding apparatus 110, which is detected in step 213. The method is selectively repeated continuously, regularly, cyclically or intermittently to detect a change to the parameters that occurs or an input by the user and to adapt the regulation of the temperature accordingly. Also, a check is selectively made as to whether a sufficient quantity of liquid 70 is present in the container 80, so that the method 200 can be carried out. For the case in which no container 80 is present or for the case in which no liquid 70 (or an insufficient amount thereof) is present in the container, the method ends at step 216.

Although the invention has been illustrated and explained in more detail by way of preferred exemplary embodiments, the invention is not restricted by the disclosed examples, and other variations may be derived from these by a person skilled in the art without departing from the scope of protection of the invention. It is therefore clear that a large number of possible variations exist. It is likewise clear that embodiments mentioned by way of example are actually only examples which are not to be understood in any way as being restrictive for instance for the scope of protection, the possible uses or the configuration of the invention. Rather, the preceding description and the description of the figures enables a person skilled in the art to realize in practice the exemplary embodiments, wherein a person skilled in the art, with knowledge of the disclosed concept of the invention, can make various changes, for example with regard to the function or the arrangement of individual elements mentioned in an exemplary embodiment, without departing from the scope of protection, which is defined by the claims and their legal equivalents, such as for example further explanations in the description.

1.-10. (canceled)

11. A method for controlling a temperature of a liquid in a container accommodated in a holding apparatus, the holding apparatus comprising one or more temperature controllers which are configured to regulate a temperature of the liquid, the method comprising:
detecting the container accommodated in the holding apparatus;
determining one or more parameters;
determining a target temperature on the basis of the one or more parameters;
detecting the temperature of the liquid;
determining a deviation between the target temperature and the detected temperature; and
controlling the one or more temperature controllers on the basis of the deviation.

12. The method according to claim 11, wherein the one or more temperature controllers are configured to regulate the temperature of the liquid indirectly at least via one part of the container, and the part of the container comprises at least one of at least one part of a base of the container or at least one part of a side wall of the container.

13. The method according to claim 11, wherein controlling the one or more temperature controllers comprises at least one of:
controlling the one or more temperature controllers to increase the temperature of the liquid to the target temperature;
controlling the one or more temperature controllers to reduce the temperature of the liquid to the target temperature; or
controlling the one or more temperature controllers to keep the temperature of the liquid substantially equal to the target temperature.

14. The method according to claim 11, wherein the one or more parameters comprise one or more user-specific parameters which are configured to map an input by or a behavior of a user, and the one or more user-specific parameters comprise at least one of:
a desired target temperature for hot drinks or cold drinks;
a desired minimum temperature;
a desired maximum temperature; or
a temperature input at an earlier point in time.

15. The method according to claim 11, wherein the one or more parameters comprise one or more context-specific parameters which are configured to map a context of the method, and the one or more context-specific parameters comprise at least one of:
an internal surroundings temperature which indicates an inside temperature;
an external surroundings temperature which indicates an outside temperature;
a time of day;
a date; or
a place.

16. The method according to claim 11, further comprising:
detecting an input by a user; and
determining the target temperature on the basis of the input and on the basis of the one or more parameters.

17. The method according to claim 11, further comprising:
detecting whether the container remains accommodated in the holding apparatus; and
deactivating the one or more temperature controllers if the container is no longer accommodated in the holding apparatus.

18. The method according to claim 11, further comprising:
detecting whether the container accommodated in the holding apparatus contains the liquid; and
detecting the temperature of the liquid if the container accommodated in the holding apparatus contains the liquid.

19. A system for controlling a temperature of a liquid in a container, the system comprising:
a holding apparatus which is configured to accommodate one or more containers;
one or more temperature controllers which are configured to regulate the temperature of the liquid in the container received by the holding apparatus indirectly at least via one part of the container; and
a control unit which is connected to the one or more temperature controllers and which is configured to carry out the method according to claim 11.

20. A vehicle comprising a system according to claim 19, wherein the vehicle comprises a motor vehicle.
